(19) United States
(12) Patent Application Publication
(10) Pub. No.: US 2025/0227137 A1
(43) Pub. Date: Jul. 10, 2025

(54) CONTENT DELIVERY

(71) Applicant: BRITISH TELECOMMUNICATIONS PUBLIC LIMITED COMPANY, London, Greater London (GB)

(72) Inventors: Michael NILSSON, London (GB); Stephen APPLEBY, London (GB); Rory TURNBULL, London (GB); Timothy STEVENS, London (GB)

(21) Appl. No.: 18/850,779

(22) PCT Filed: Mar. 14, 2023
(86) PCT No.: PCT/EP2023/056509

§ 371 Date: Sep. 25, 2024

(30) Foreign Application Priority Data
Mar. 29, 2022 (GB) 2204460.6

(51) Int. Cl. H04L 65/611; H04L 65/752

(52) U.S. Cl. CPC H04L 65/611; H04L 65/752

(57) ABSTRACT

The present invention provides a method of controlling the delivery rate of content to a client device to influence the quality level at which the client device requests subsequent content segments. The aim is to influence the client device so that it requests content segments at a consistent adaptive bit rate (ABR) level, where that level is one at which many client devices are requesting content segments. The result is that requests are more concentrated around a subset of the available ABR levels. This enables a more efficient and widespread use of any subsequent multicast.

### FIELD OF THE INVENTION

This invention relates to the field of managing content delivery in a network, in particular managing content delivery using a combination of unicast and multicast.

### BACKGROUND TO THE INVENTION

Video content is currently commonly delivered to a range of client devices using unicast delivery, where a single stream of data is transmitted to each individual client device. Web (HTTP) technology is used for the content delivery, where the content is segmented into short segment files, typically around six to ten seconds in duration, enabling each segment file to be requested by and delivered to the client device using HTTP.

Each segment may also be encoded at a set of quality levels, each with a different bit rate and hence different file size. The client device monitors its buffer level and the network throughput achieved, and determines from these at which quality to request the next segment in order to achieve a good compromise between media quality and timely delivery. This is commonly referred to as adaptive bitrate (ABR) streaming.

However, HTTP is delivered over unicast (one to one) transport, so is inefficient for delivering the same content at the same time to many client devices. Multicast (one to many) transport would be far more efficient. Yet multicast is currently rarely used for any services other than network operators' on-net linear video channels delivered to their own set-top boxes. The main reason for this is that multicast does not lend itself to open use on the Internet.

To bring the benefits of multicast scalability to HTTP-based Internet media streaming, a class of techniques known as Multicast-Adaptive Bitrate (m-ABR) is being investigated and standardised.

Multicast-Adaptive Bitrate (m-ABR) is a relatively new technology. It aims to allow more efficient delivery of ABR content over networks by enabling the use of multicast for content streams where many clients are requesting the same content at about the same time.

One ambition of many m-ABR systems is to deploy multicast and enable m-ABR without any change to the client device and the client application that are already supporting HTTP (unicast) streaming. This can be achieved using a hybrid approach that uses a combination of both multicast and unicast delivery, where a proxy is inserted between the client device and the content server. The proxy can inspect content requests from the client device, and when appropriate, subscribe to a multicast stream, receive multicast content, and provide this content to the client, packaged to look like unicast delivered content.

Examples of such hybrid solutions include: “IP Multicast Adaptive Bit Rate Architecture Technical Report” OC-TR-IP-MULTI-ARCH-C01-161026, 26/10/2016, by Cable Labs; 3GPP specifications, 23.246 (MBMS Architecture and functional description), 26.346 (MBMS Protocols and codecs) and 26.347 (MBMS APIs); and DVB “Adaptive Media Streaming over IP Multicast” ETSI TS 103 769 V1.1.1 (2020-11).

There are several problems related to the rate and timing of the delivery of data that prevent such an m-ABR system from functioning correctly.

As described, ABR delivery involves encoding the content at multiple quality levels, at different encoded bit rates, to enable clients to request content segments at quality levels and bit rates that are appropriate for their current network throughput. However, in m-ABR systems, multicast is usually only provided with a subset of the bit rates from the ABR hierarchy that are available over unicast. Therefore, a client that requests content segments at a quality level in the ABR hierarchy that is not available by multicast will not be able to receive those content segments by multicast.

Furthermore, a client that is frequently switching between different levels in the ABR hierarchy when making requests will also have difficulty receiving content segments by multicast. This is because it takes time and resources to change the multicast stream that a client is subscribed to, and it is inefficient to deliver content segments at one quality level by multicast and at another quality level by unicast, if the client has switched to requesting segments at a different level in the ABR hierarchy to the level that is being received by multicast.

### SUMMARY OF THE INVENTION

It is the aim of examples of the present invention to provide an improved content delivery mechanism that addresses one or more of the above problems.

According to one example of the invention, there is provided a method of managing content delivery by a proxy in a network, said network comprising a rate assessment module connected to a plurality of proxies each connected to respective one or more client devices, said content comprising a sequence of segments wherein each of the segments is encoded at a plurality of bit rates, said method comprising:
i) receiving requests for segments from each of the plurality of client devices at a respective proxy, and determining the encoded bit rate corresponding to each requested segment;
ii) identifying by the rate assessment module a subset of the encoded bit rates as the most frequently requested bit rates;
iii) receiving requests for segments from a target client device at a respective proxy, and determining the further encoded bit rates associated with the requested segments from the target client device;
iv) selecting one of the subset of encoded bit rates based on the further encoded bit rates;
v) when encoded bit rate of the most recently requested segment from the target client device is higher than the selected bit rate, delivering the most recently requested segment from the proxy to the target client device at a delivery rate lower than the rate at which the requested segment was received by the proxy

The selected one of the subset of encoded bit rates may be the further encoded bit rate at which the majority of the further requested segments are encoded at.

Examples of the invention allow the rate at which content segments are delivered to the client device to be controlled to influence the quality at which the client device requests subsequent content segments. The aim is to influence the client device so that it requests content segments at a consistent ABR level, where that level is one at which many client devices are requesting content segments. The result is that requests are more concentrated around a subset of the available ABR levels. This enables a more efficient and widespread use of any subsequent multicast.

Subsequent network optimisation techniques, such as caching and multicast, are made more efficient, as more clients are requesting the same content at the same bitrates.

Otherwise, adaptive bitrate clients' ability to select from multiple bitrates independently of one another can work against network optimisation techniques, without necessarily improving the quality of experience.

The invention operates without explicit knowledge of the media bitrates—where any required information can be inferred from observations of the HTTP request and response pairs.

### BRIEF DESCRIPTION OF THE DRAWINGS

For a better understanding of the present invention reference will now be made by way of example only to the accompanying drawings, in which:

FIG. 1 is a system diagram showing the main components of an example of the present invention;

FIG. 2 is an example histogram showing the size of requested content segments;

FIG. 3 is a table showing an example of the calculated size of segments and the encoded bit rate;

FIG. 4 is a table showing an example summary of the requests for content segments at each of the calculated bit rate levels;

FIG. 5 is a flow chart summarising the steps of an example of the invention.

### DESCRIPTION OF PREFERRED EMBODIMENTS

The present invention is described herein with reference to particular examples. The invention is not, however, limited to such examples.

Examples of the present invention provide a method of controlling the delivery rate of content to a client device to influence the quality level at which the client device requests subsequent content segments. The aim is to influence the client device so that it requests content segments at a consistent adaptive bit rate (ABR) level, where that level is one at which many client devices are requesting content segments. The result is that requests are more concentrated around a subset of the available ABR levels. This enables a more efficient and widespread use of any subsequent multicast.

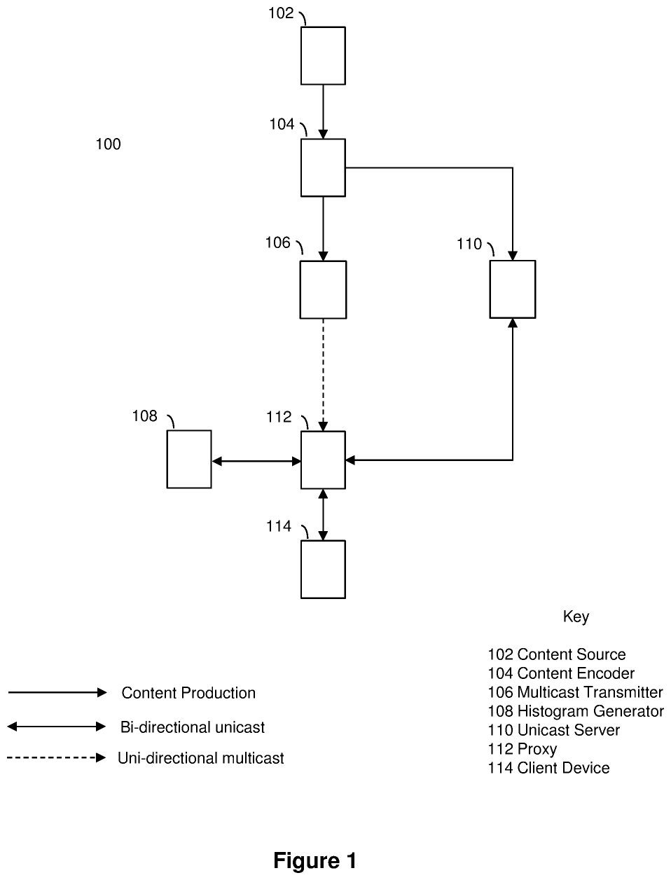

FIG. 1 shows an adaptive bit rate (ABR) streaming system 100 comprising the main components of an example of the invention. The system 100 comprises a content source 102, a content encoder 104, a multicast transmitter 106, a rate assessment module 108, a unicast content server 110, a proxy 112 and a client device 114. The content source 102 provides content, such as a live sports or TV broadcast, in the form of video sequences to the content encoder 104.

The proxy 112 may be located within a device such as a home gateway or router.

The client device 114 is assumed to be running a client application, which is the source of content requests. For simplicity, the term client device has been used to refer to a client device running a client application.

The content encoder 104 receives the content from the content source 102 and encodes it using a suitable compression scheme, such as ITU-T Recommendation H.264 for video content, and segments the encoded content into a sequence of content segments, each content segment typically of duration 2 to 10 seconds. The content encoder 104 also encodes the content at one or more quality levels or bit rates, resulting in one or more (at each quality level) encoded segments corresponding to each uncompressed content segment. Such an arrangement is typical of an adaptive bit rate streaming service.

The content segments encoded at one quality level, corresponding to one encoded bit rate, are passed to the multicast transmitter 106 for transmission by multicast to any devices that have subscribed to the respective multicast source. However, the invention is not limited to this case, and also applies when content segments encoded at a plurality of quality settings, corresponding to a plurality of encoded bit rates, are passed to the multicast transmitter 106 for transmission by multicast on a plurality of multicast channels (one channel per quality setting).

The multicast transmitter 106 transmits the stream of encoded content segments on a suitably configured multicast channel to all devices that have subscribed to that multicast channel.

The system 100 also includes a rate assessment module 108, the operation of which will be described later.

The content encoder 104 passes the encoded content segment data, encoded at all of the required bit rates, to the unicast server 110 where the data is stored and made available for delivery by unicast. The unicast server 110 responds to unicast requests for content segments with unicast responses using the stored data.

The client device 114 can obtain a manifest file from the unicast server 110. Manifest files are used by client devices to identify where segments are located (by a URL in the manifest). The client device 114 can then request these segments in sequence using HTTP requests from the unicast server 110, and concatenate them to form a continuous stream of segments for playback. As each segment is available on the unicast server 110 at a plurality of encoded bit rates, the client device 110 determines for each content segment, the encoded bit rate (quality) at which to request it, taking into account such factors as the available network throughput and how much data is already received and buffered at the client device awaiting play-out.

Some HTTP requests made by the client device 114 for content will not make use of multicast delivery and are sent directly to the unicast server 110, which delivers the requested content by unicast. Other requests for content from the client device 114 that may benefit from multicast delivery are re-directed to, or simply intercepted by, the proxy 112, and can be handled in accordance with the examples described below.

The client device 114 could request and receive segments from the unicast server 110 from the start to the end of a streaming session. However, in some cases the proxy 112 determines that multicast delivery could be used to receive some segments.

The proxy 112 monitors unicast content requests from the client device 114 and is aware of when content requested by the client device 114 could be received by multicast.

The proxy 112 determines when it is possible to satisfy the client device's requests for content using data that could be delivered by multicast, joins the relevant multicast channel at an appropriate time, and, after receiving data by multicast, replies to the client device's requests for unicast content with content received by multicast, but packaged as a unicast content response.

The client device 114 does not need to be aware of the proxy 112 and does not need to be aware of whether content is being delivered by unicast from the unicast content source via the proxy, or is delivered by multicast to the proxy which then delivers the content to the client device 114 in a unicast format.

There are many ways in which the proxy 112 may determine it is possible to satisfy the client device's requests for content using data that could be delivered by multicast.

For example, if client device 114 has made a plurality of consecutive requests for content segments at the same encoding quality level, that quality level is available by multicast delivery, and each of these content segments has been delivered in less time than the segment period.

In another example, the proxy 112 may ignore the fact that some segments have taken more time than a segment period to be delivered, provided that many segments are delivered in much less than a segment period. The proxy 112 may also ignore some variations in the quality at which segments are requested, if for much or all of the time there is easily sufficient network throughput to deliver content segments at the quality level available by multicast.

In typical systems, when the proxy 112 has decided to satisfy the client device's requests for content using data that could be delivered by multicast, the proxy 112 stops forwarding the client device's requests for content to the unicast server 110, and instead takes appropriate action to join and obtain from the multicast channel, the data requested by the client device 114. The proxy 112 then delivers that content received over multicast to the client device 114, with the data formatted as a unicast response.

However, such an approach can result in the problems identified earlier, where not all the quality levels might be available for multicast, or when a client frequently switches between different levels in the ABR hierarchy. Described now are examples of how content delivery can be managed in an improved manner that mitigates some of these problems.

In the examples, it is envisaged that the system 100 may include a plurality of client devices. Each client device 114 is logically associated with one proxy 112, although in practice a single proxy could serve content to more than one client device. In such a case, the proxy may only need to receive one copy of a content segment from the unicast server 110 or the multicast transmitter 106, even when requested by more than one client device.

Examples of the invention apply independently to each content stream. A content stream could be identified using elements of the URL's domain and path associated with the requested segment. For example, it may be possible to identify a stream from a path prefix or using a regular expression. In the description below, it will be assumed that all URLs relate to the same content stream.

An example of the invention is described as follows.

The client device 114 makes requests for segments of content from the unicast server 110. These requests, and the associated responses, pass through the proxy 112.

If it is known, the proxy 112 stores the ABR level, Lₙ, at which the client device 114 has requested the content segment, index n. The proxy 112 also stores the time, tₙ, at which the request was made by the client device 114, stores the size, Sₙ, in, for example, bytes, of the segment that is delivered from the unicast server 110, and determines and stores the rate, Rₙ, at which the segment is delivered to the proxy 112 from the unicast server 110.

The proxy 112 may be able to determine the ABR level, Lₙ, at which the client device 114 has requested the content segment from the URL used by the client device 114 to request the content segment. For example, if the client device 114 has requested https://t2-btsport-live-hls-prod.akamaized.net/out/u/bts1/bts1_7_15055280.ts?m=1543850508, then if the proxy 112 understands the format of the URL, it could determine that the client device 114 has requested the content segment at ABR level Lₙ equal to 7.

From time to time, which may be after every content segment request and response, or less frequently, the proxy 112 reports to the rate assessment module 108 the data that it has stored about the requests that the client device 114 has made for content segments.

This data may include Lₙ (ABR level), tₙ (time), Sₙ (size) and Rₙ (Rate) for one or more segments.

The system 100 may include a plurality (or population) of proxies, where each of the proxies has one or more client devices connected to it, and where each proxy will receive requests for content segments from one or more of the client devices connected to it.

There is therefore effectively a population of proxies as well as a population of client devices in the system 100. Each proxy is connected to the rate assessment module 108.

The rate assessment module 108 receives information from the population of proxies about the content segments requested by the population of client devices. If the population of proxies are able to provide the ABR levels, Lₙ, at which content segments have been requested, then the rate assessment module 108 can use this information directly. Otherwise, the rate assessment module 108 can analyse the distribution of the size, Sₙ, of content segments that have been delivered to associate an ABR level with each requested content segment.

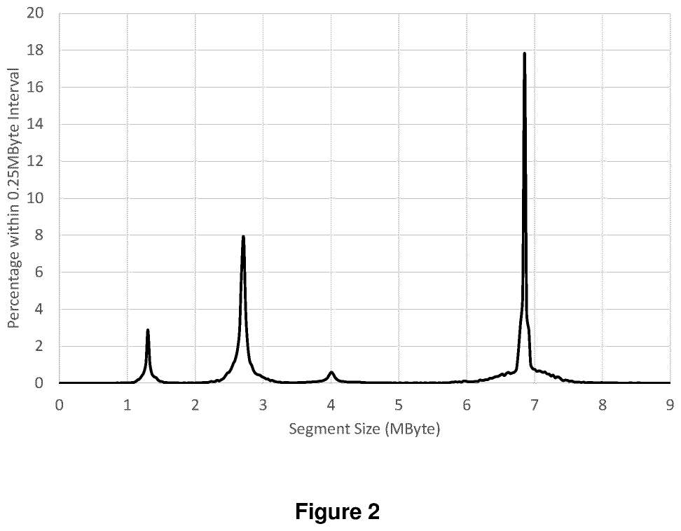

FIG. 2 shows an example of a histogram that the rate assessment module 108 could generate from the information it receives from the population of proxies about the size of segments that have been requested by the client devices. As most HTTP Adaptive Streaming systems use constant bitrate encoding for the segments, the sizes of the segments will cluster around a set of discrete values, each such discrete value corresponding to one nominal encoded bit rate. Larger segment sizes tend to be associated with higher nominal encoded bit rates and higher video quality. FIG. 2 shows clustering around four discrete values.

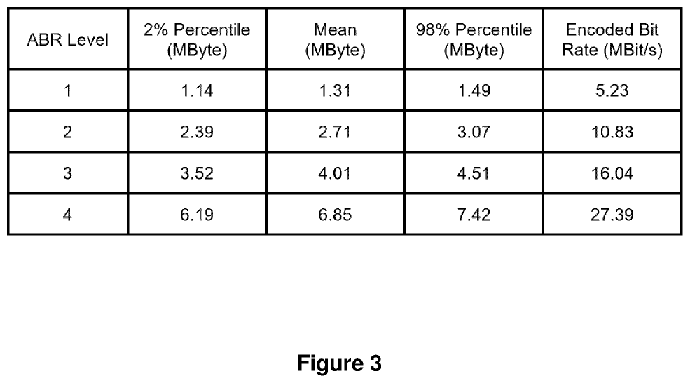

The rate assessment module 108 may analyse these statistics on the size of requested content segments to generate summary statistics for ABR levels. An example is shown in FIG. 3, where the rate assessment module 108 has identified four ABR levels, and for each has calculated a mean segment size, and the 2% and 98% percentiles. In this case there is no overlap between the 98% percentile of one ABR level and the 2% percentile of the next higher ABR level. These statistics can be used by the rate assessment module 108 and the proxy 112 to associate a requested content segment with an ABR level using the size of the content segment. This association may not actually be correct in all cases, but any such misclassification does not prevent the system from operating.

The rate assessment module 108 may also determine an encoded bit rate for each of the identified ABR levels by analysing the time interval between requests for content segments from the same client device. Typically, a client device would request a content segment at regular periods equal to the segment interval, but this may not always be the case. In some cases, a client device may request the same segment more than once, usually at a different quality level (different encoded bit rate). And sometimes a client device would have longer periods between making requests for content segments, for reasons including low network throughput preventing the delivery of content segments in a segment period, and the user pausing playback and later resuming. However, the rate assessment module 108 may determine a good estimate for the segment interval by calculating a typical time interval between requests for a content segment from a client device over the requests from a plurality of client devices. One method of calculating such a typical time interval between requests for a content segment is to use the median of the time intervals.

The rate assessment module 108 processes the information it has received from the population of proxies to determine at which of the identified ABR levels content segments have been requested frequently, and at which of the identified ABR levels content segments have been requested much less frequently. The rate assessment module 108 may do this for example by creating a histogram of the frequency at which content segments have been requested at the different ABR levels. If the population of proxies are able to provide the ABR levels, Lₙ, at which content segments have been requested, then the rate assessment module 108 can use this information directly, otherwise the classification described above using the size of requested content segments can be used.

ABR Level 1 is a low bit rate, low quality, level that is used by some client devices when network throughput is poor. To maintain continuity of service it is important that client devices can request and receive this ABR level. ABR levels 2, 3 and 4 provide increasing levels of quality with increasing bit rate requirements.

The rate assessment module 108, in consideration of the processed data, may conclude that as ABR levels 2 and 4 are requested frequently that these should be made available by multicast. And as ABR level 3 is requested much less frequently, this should not be made available by multicast. But in addition, overall system performance could be improved if client devices would request content segments at ABR level 2 or 4. Caching could be more effective for unicast delivery if content segments were not requested at ABR level 3, and more use could possibly be made of multicast if more content segments were requested at ABR level 2 or 4 as these ABR levels are most likely to be made available by multicast given they are most frequently requested.

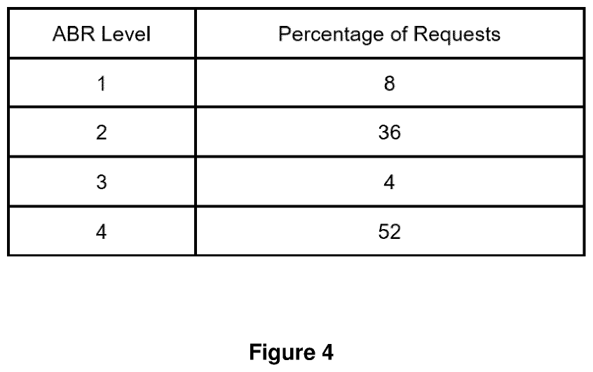

Reference is made to the summary statistics in the table of FIG. 4, which shows the processed data summarised by the percentage of requests for each ABR level. In this example, ABR levels 1 and 3 have the lowest percentage of requests, and ABR levels 2 and 4 have the higher percentage of requests.

The rate assessment module 108 reports to the population of proxies the information it has determined about ABR levels, the size of segments and the encoded bit rate, such as shown in FIG. 3. It also reports that content segments are requested frequently at ABR levels 2 and 4 and are requested much less frequently at ABR level 3, such as shown in the summary table of FIG. 4. The rate assessment module 108 may provide guidance to the population of proxies based on this information, for example to take no action to try to influence the ABR level decisions of the client device, or to take action to try to influence the ABR level decisions of the client device to avoid the selection of one or more specific ABR levels.

If the proxy 112 was previously unable to determine the ABR level Lₙ from the request made by the client device 114 for segment n, for example, by being unable to parse it from the HTTP GET Request, the proxy 112 determines a likely ABR level Lₙ using the statistics provided by the rate assessment module 108 and the stored size of segment, Sₙ, and stores the determined value of Lₙ. As an example, using the information in FIG. 3, if the stored size of segment Sₙ=3.89 MByte, the proxy 112 may conclude that the segment was requested at ABR level 3, as this size is between the 2% and 98% percentiles of segment size for ABR level 3 as reported by the rate assessment module 108.

The proxy 112 receives and acts on this information and guidance from the rate assessment module 108. The proxy 112 may set a parameter indicating its mode of operation, M, accordingly. It may set M equal to “off” if the rate assessment module 108 suggests taking no action to try to influence the ABR level decisions of the client device. Otherwise, the proxy 112 may set M equal to one of two possible values in dependence on whether the proxy 112 considers it appropriate to follow the guidance from the rate assessment module 108 to try to influence the ABR level decisions of the client device.

The proxy 112 considers the data that it had collected and stored previously concerning the ABR level at which the client device 114 has requested content segments. In the case of the client device 114 having requested content segments at a consistent ABR level, even if that level is a level that the rate assessment module 108 has indicated is requested much less frequently than other levels, such as at ABR level 3 in the example above, the proxy 112 may determine to take no specific action in response to the information from the rate assessment module 108 and may set M equal to “unconstrained”.

In the case of the client device 114 having requested content segments at inconsistent ABR levels, and especially in the case of the client device 114 having requested a majority of content segments at a lower level than an infrequently requested level as indicated by rate assessment module 108 (for example, referring to FIG. 4, at ABR Level 3), the proxy 112 may take action to try to influence the client device 114 to not request subsequent content segments at an infrequently requested level and may set M equal to “limited”.

In this example, in the case of the client device 114 having requested a majority of content segments at ABR level 2 or lower, and a minority at ABR level 3, the proxy 112 may take action to influence the client device 114 to not request subsequent content segments at ABR level 3, but preferably at ABR level 2. Although this may result in some content segments being requested at ABR level 2 rather than ABR level 3, the quality of experience for the user of the client device 114 may actually be improved as consistent quality has been found to provide better quality of experience than variable quality. In addition, by the client device 114 consistently requesting content segments at ABR level 2, multicast could be used to deliver content segments to the proxy 112, reducing the demand on the network and on the unicast server 110, which may in turn allow higher quality content segments to be delivered to some client devices.

The proxy 112 uses the mode of operation parameter M to indicate which of these two modes of operation is in use, that is, whether or not to try to influence the client device 114 to not request content segments at an ABR level that is requested infrequently by the population of client devices.

When M is equal to “limited”, the proxy 112 maintains an upper threshold T and uses this to limit the rate at which content segments are delivered from the proxy 112 to the client device 114, to try to influence the ABR level at which the client device 114 requests content segments.

When M is equal to “unconstrained”, the proxy 112 makes no changes to the upper threshold T and does not use this threshold at all, and simply forwards content segments received from the unicast server 110 to the client device 114 as fast as they are received from the unicast server 110.

The proxy 112 may determine whether to set M equal to “limited” or “unconstrained” according to the information it has stored about requests for content segments from the client device 114.

The proxy 112 may calculate, using one of more stored values of Rₙ for content segments that have been recently requested and delivered, an average rate of delivery, R̅ₙ, for the delivery of content segments from the unicast server 110 to the proxy 112. This average rate could be calculated as an arithmetic, geometric, or harmonic mean of the values of Rₙ, or as the median or a specific percentile, or as any other representative value. As an example, R̅ₙ could be calculated as the arithmetic mean of the most recent five values of Rₙ.

The proxy 112 may calculate, using one of more stored values of Lₙ, an average ABR level, Lₙ, for content segments that have been recently requested. This too could be calculated as any representative value. As an example, L̅ₙ could be calculated as the arithmetic mean of the most recent five values of Lₙ.

The proxy 112 may use these calculated values of R̅ₙ and L̅ₙ to set or change the value of M.

If M is equal to “limited”, the proxy 112 may determine to change M to “unconstrained” if recently requested content segments have been delivered from the unicast server 110 to the proxy 112 relatively quickly. For example, the proxy 112 may compare R̅ₙ to a bit rate threshold, and if greater than that threshold, set M equal to “unconstrained” so that the rate at which subsequent content segments are delivered from the proxy 112 to the client device 114 is not limited by the proxy 112. For example, by setting the bit rate threshold to the encoded bit rate of ABR level 4, M will be changed to “unconstrained” when there is on average sufficient data rate for timely delivery of segments at ABR level 4.

If M is equal to “unconstrained”, the proxy may determine to change M to “limited” if content segments have recently been requested at lower ABR levels, such as at ABR levels 2 and 3. For example, the proxy 112 may compare L̅ₙ to an ABR level threshold, and if less than that threshold, set M equal to “limited” to try to influence the client device 114 to not request subsequent content segments at ABR level 3. By setting the ABR level threshold to 3, the proxy 112 will switch to trying to influence the ABR decisions of the client device 114 when more segments are requested at ABR level 2 than at ABR level 4.

Described below is how the proxy 112, when the mode of operation parameter M is equal to “limited”, may take action to try to influence the client device 114 to not request subsequent content segments at ABR level 3 and instead to request subsequent content segments at ABR level 2, by controlling the rate at which content segments are delivered from the proxy 112 to the client device 114.

The aim is for the proxy 112 to deliver content segments to the client device 114 at a rate that influences the client device 114 to request subsequent content segments at ABR level 2, while not preventing the client from requesting subsequent content segments at ABR level 4 if permitted by the network conditions. The proxy 112 may also choose to stop controlling the rate at which content segments are delivered to the client device 114 if the proxy considers that the client device 114 will request content segments consistently at ABR level 3 and above, as in this case influencing the client device 114 to consistently request content segments at ABR level 2 could significantly reduce video quality.

The proxy 112 sets an initial upper threshold, T, on the rate at which it will deliver content segments to the client device 114. The proxy 112 will be unable to deliver a content segment to the client device 114 at rate T if the content segment is received at the proxy 112 from the unicast server 110 at a lower rate than T. This initial upper threshold, T, can be set in various ways, including but not limited to, the encoded bit rate of ABR level 3 as indicated by the rate assessment module 108, or the rate or average of the rates at which one or more preceding segments were received from the unicast server 110.

Subsequently, in the event of the client device 114 requesting a content segment at a higher ABR level than ABR level 2, it is likely that the bit rate used by the proxy 112 to deliver the preceding one or more content segments to the client device 114 was too high, and hence the proxy 112 should reduce the upper threshold, T, on the rate at which it delivers content segments to the client device 114. The proxy 112 may, for example, reduce the value of the upper threshold, T, by multiplying it by a positive factor less than one, for example 0.97.

In the event of the client device 114 requesting a content segment at a lower ABR level than ABR level 2, and the proxy 112 having delivered the preceding one or more content segments to the client device 114 at a rate lower than that at which the proxy 112 had received those preceding one or more content segments from the unicast server 110, it is likely that the bit rate used by the proxy 112 to deliver the preceding one or more content segments to the client device 114 was too low, and hence the proxy 112 should increase the upper threshold, T, on the rate at which it delivers content segments to the client device 114. The proxy 112 may, for example, increase the value of the upper threshold, T, by multiplying it by a positive factor more than one, for example 1.03.

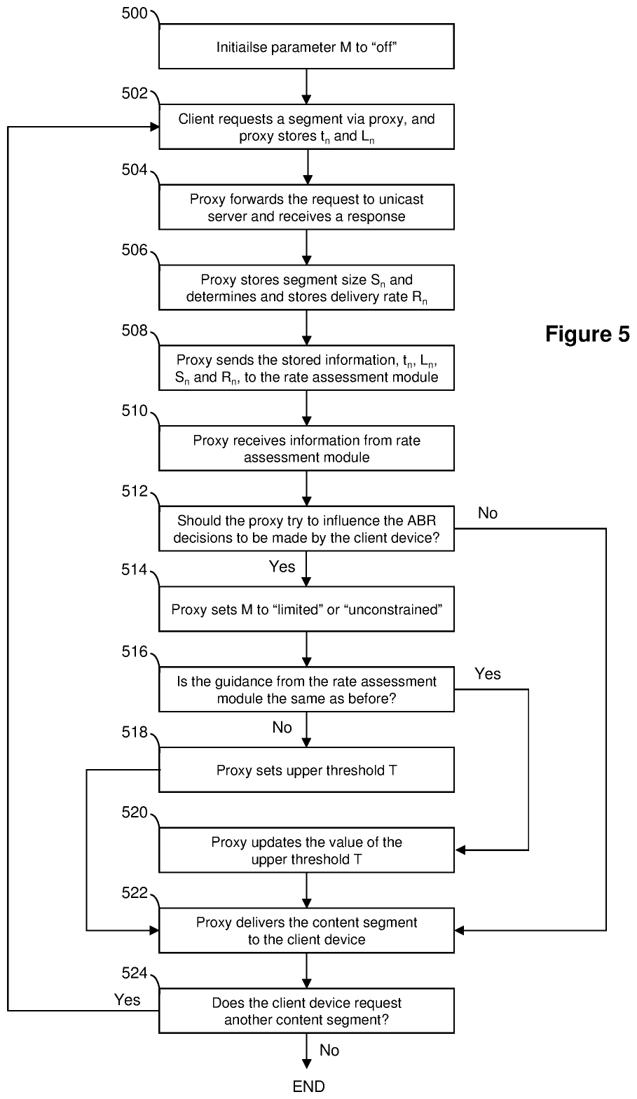

Examples will now be described with reference to the flow chart shown in FIG. 5.

In step 500, the proxy 112 initialises a parameter, M, which indicates the mode of operation, to “off”. This indicates that the proxy 112 has not received guidance from the rate assessment module 108 to try to influence the ABR level at which the client device 114 requests content segments, and hence the proxy 112 forwards content segments to the client device 114 as fast as they are received from the unicast server 110.

In step 502, the proxy 112 receives a request from the client device 114 for content segment n, at time tₙ, at ABR level Lₙ. The proxy 112 may not be able to determine Lₙ from the parameters of the request. The proxy 112 stores tₙ, and if known, stores Lₙ.

In step 504, the proxy 112 forwards this request to the unicast server 110 and receives the requested segment in response.

In step 506, the proxy 112 stores the size of the segment, Sₙ, and determines and stores the rate, Rₙ, at which this content segment is received by the proxy 112 from the unicast server 110.

In step 508, the proxy 112 sends the information tₙ, Sₙ, Rₙ, and if known, Lₙ, to the rate assessment module 108. The proxy 112 may choose not to do this for every content segment and may instead send the information for more than one content segment after these content segments have been requested and received.

In step 510, the proxy 112 receives from the rate assessment module 108 statistics determined from information received from the population of proxies. These statistics may include statistics relating to ABR levels including, for each of a plurality of ABR levels, the mean segment size, indications of the range of the segment sizes, and the estimated encoded bit rate.

The proxy 112, if unable previously to determine the ABR level Lₙ, determines a likely ABR level Lₙ using the statistics provided by the rate assessment module 108 and the stored size of the segment, Sₙ, and stores the determined value of Lₙ.

In step 512, the proxy 112 considers further information received from the rate assessment module 108, which may include statistics indicating the relative frequency at which content segments had been requested at each of the plurality of ABR levels and may include guidance to the proxy 112 of whether to try to influence the client device 114 to not request content segments at one or more specific ABR levels.

If the rate assessment module 108 has indicated that the proxy 112 should not try to influence the ABR level decisions to be made by the client device 114, the proxy 112 sets the mode of operation parameter M to “off”, and flow passes to step 522, otherwise flow passes to step 514.

In step 514, the proxy 112 sets the mode of operation parameter M to either “limited” or “unconstrained”. The proxy 112 sets this parameter in dependence on parameters including the ABR level at which the client device 114 has requested one or more preceding content segments, and on the rate at which one or more preceding content segments have been delivered from the unicast server 110.

The aim of the proxy 112 is to try to influence the client device 114 to not make occasional requests for ABR level 3 amongst a majority of requests for ABR level 2 and instead make consistent requests for ABR level 2, while if the client device 114 is requesting content segments consistently at ABR level 3 and above, allowing it to continue to do so. In the former case the proxy 112 sets M to “limited”, while in the latter case the proxy 112 sets M to “unconstrained”.

For example, if the one or more preceding content segments have been requested mostly at ABR level 2 but some at ABR level 3, and if the rates at which these content segments have been delivered are generally less than the encoded bit rate for ABR level 3, the proxy may set M to “limited”. But if the one or more preceding content segments have been requested at ABR level 3 or higher, and if the rates at which these content segments have been delivered are significantly higher than the encoded bit rate for ABR level 3, the proxy may set M to “unconstrained”.

The proxy 112 may also apply hysteresis in determining the setting of M to reduce the frequency of switching between M equal to “limited” and M equal to “unconstrained”. For example, the threshold on the rate at which the one or more preceding content segments have been received from the unicast server 110 may be higher for changing M from “limited” to “unconstrained” than the threshold for changing M from “unconstrained” to “limited”.

In step 516, if the guidance from the rate assessment module 108 relating to trying to influence the ABR level decisions to be made by the client device 114 is the same as guidance previously received by the proxy 112, flow passes to step 520, otherwise flow passes to step 518. Such a change in guidance includes changing from not trying to influence the ABR level decisions to be made by the client device 114 to trying to influence them; and includes changing at which specific ABR levels to try to influence the client device 114 to not request content segments.

In step 518, the rate assessment module 108 has given new or different guidance to the proxy 112 relating to trying to influence the ABR level decisions to be made by the client device 114.

Regardless of the value to which the proxy 112 has set M, the proxy 112 sets an upper threshold, T, on the rate at which it will deliver content segments to the client device 114. This upper threshold, T, can be set in various ways, including but not limited to, the encoded bit rate of ABR level 3 as indicated by the rate assessment module 108, or the rate or average of the rates at which one or more preceding content segments were received from the unicast server 108. As described below, the proxy 112 only applies this upper threshold, T, when M= “limited”.

Flow passes to step 522.

In step 520, if the mode of operation M is equal to “limited”, the proxy 112 determines whether to adjust the value of the upper threshold, T, and if so, adjusts it accordingly. Otherwise, that is, if the mode of operation M is not equal to “limited”, the proxy 112 makes no change to the value of the upper threshold, T.

If the mode of operation M is equal to “limited” and the ABR level of the content segment is higher than ABR level 2, the proxy 112 reduces the upper threshold, T, by, for example, multiplying it by a positive factor less than one, for example 0.97.

If the mode of operation M is equal to “limited” and the ABR level of the content segment is lower than ABR level 2, and the previous segment was received faster than rate T from the unicast server 110, that is, if Rₙ₋₁>T, the proxy 112 increases the upper threshold, T, by, for example, multiplying it by a positive factor greater than one, for example 1.03.

In step 522 the proxy 112 delivers the content segment data to the client device 114 as a unicast response to the request from the client device 114. The client device 114 receives this content segment data, which can then be played out.

If the mode of operation parameter M equals “limited”, the proxy 112 controls the rate this content segment is delivered to the client device 114 to be as fast as it is received from the unicast server 110, Rₙ, but no faster than the upper threshold, T. Otherwise, the proxy 112 delivers the content segment data to the client device 114 as fast as it is received from the unicast server 110, Rₙ. This is shown in the equation (1) below:

$$Delivery Rate = \{ \begin{matrix}Min ( {R}_{n} , T ) & if M = limited \\ {R}_{n} & otherwise\end{matrix} \qquad ( 1 )$$

In step 524, if the proxy 112 receives another request for a content segment from the client device 114, the variable n is increased by one and flow passes to step 502, otherwise flow terminates.

Note that in these examples, references to ABR level 3 can be generalised to infrequently requested level, and references to ABR level 2 or 4 can be generalised to frequently requested level. Reference to the specific level number has been made to simplify the description of the examples.

In general, it is noted herein that while the above describes examples of the invention, there are several variations and modifications which may be made to the described examples without departing from the scope of the present invention as defined in the appended claims. One skilled in the art will recognise modifications to the described examples.

1. A method of managing content delivery by a proxy in a network, said network comprising a rate assessment module connected to a plurality of proxies each connected to respective one or more client devices, said content comprising a sequence of segments wherein each of the segments is encoded at a plurality of bit rates, said method comprising:
i) receiving requests for segments from each of the plurality of client devices at a respective proxy, and determining the encoded bit rate corresponding to each requested segment;
ii) identifying by the rate assessment module a subset of the encoded bit rates as the most frequently requested bit rates;
iii) receiving requests for segments from a target client device at a respective proxy, and determining the further encoded bit rates associated with the requested segments from the target client device;
iv) selecting one of the subset of encoded bit rates based on the further encoded bit rates;
v) when encoded bit rate of the most recently requested segment from the target client device is higher than the selected bit rate, delivering the most recently requested segment from the proxy to the target client device at a delivery rate lower than the rate at which the requested segment was received by the proxy.

2. A method according to claim 1, wherein the selected one of the subset of encoded bit rates is the further encoded bit rate at which the majority of the further requested segments are encoded at.
